(19) United States
(12) Patent Application Publication
(10) Pub. No.: US 2026/0234350 A1
(43) Pub. Date: Aug. 13, 2026

(54) MODIFIED PU FOAM

(71) Applicant: WENATEX FORSCHUNG - ENTWICKLUNG - PRODUKTION GMBH, Braunau am Inn - Ranshofen (AT)

(72) Inventors: Karl RAMETSTEINER, Linz (AT); Stefan THUMM, Benediktbeuem (DE)

(21) Appl. No.: 19/130,486

(22) PCT Filed: Nov. 14, 2023
(86) PCT No.: PCT/AT2023/060387

§ 371 Date: May 15, 2025

(30) Foreign Application Priority Data
Nov. 15, 2022 (AT) A 50865/2022

(51) Int. Cl. C08J 9/00; C08G 18/32; C08G 18/48; C08G 18/64

(52) U.S. Cl. CPC C08J 9/0061; C08G 18/3215; C08G 18/3218; C08G 18/4829; C08G 18/6492; C08J 9/0023; C08G 2110/0008; C08J 2375/04; C08J 2497/02

(57) ABSTRACT

The present patent application relates to a PU foam comprising at least one secondary plant compound bonded thereto, preferably covalently, wherein the at least one secondary plant compound is partially or completely introduced in the form of wood particles.

### TECHNICAL FIELD

The present invention relates to a polymer and the production and use thereof.

### BACKGROUND OF THE INVENTION

Polymers like polyurethanes (PU) are used in various fields and are often chemically modified to adapt them to special requirements. For example, polyurethanes are used as molding materials for compression molding, as casting resins (isocyanate resins), as (textile) elastic fiber materials, polyurethane lacquers, and as polyurethane adhesives. In particular, soft PU foams are mainly used as upholstery material (e.g., for furniture or car seats), as mattress foam, as carpet backing material, for laminating textiles, as cleaning sponges, or as filter material. The range of use of the respective material can be adapted by adding chemical additives. The production of different objects of use through corresponding modifications of PU foams by adding functional additives is therefore common practice. Water absorption of mattresses, for example, can be reversibly changed by admixing additives to polyurethane soft foam, which strongly facilitates the conception of mattresses. However, such additives are often toxic and not biodegradable. Another example comprises the use of carcinogenic active carbon black for absorbing odorants.

An essential disadvantage of common modified PU foams is, therefore, the presence of functional chemicals harmful to the environment, which can detach from the polymer and get into the environment (e.g., the groundwater). Another disadvantage relates to the high quantities used of the functional chemicals because the compounds incorporated into the polymer core do, in many cases, not have any functional efficacy and are hard to mobilize.

Therefore, it is an object of the present invention to provide a sustainable PU foam having modified properties and high environmental compatibility.

### SHORT DESCRIPTION OF THE INVENTION

Therefore, the present invention relates to a PU foam comprising at least one secondary plant compound bonded thereto, preferably covalently, wherein the at least one secondary plant compound is partially or completely present in the form of wood particles.

Surprisingly, it has been shown that the properties of the inventive PU foam are, by the secondary plant compound bonded thereto, modified in a targeted manner, and its environmental compatibility can be increased. Depending on the structure and property of the secondary plant compound, the property of the material can be manipulated by covalently bonding it to a fiber material without using toxic and/or environmentally harmful chemicals. Secondary plant compounds are natural components that are, for example, also found in everyday nutrition and thus represent no danger to the environment or humans because they are products from biological, sustainable raw materials. The secondary plant compounds are partially or completely present in the PU foam in the form of wood particles. The wood particles are biological, sustainable raw materials and enhance or expand the properties of the PU foam obtained by the secondary plant compounds.

Another aspect of the present invention relates to a method for producing PU foam comprising the step of reacting at least one polyol component with at least one isocyanate component in the presence of a propellant and at least one catalyst, which catalyzes the isocyanate-polyol reactions, wherein at least one secondary plant compound is admixed during the reaction of the at least one polyol component with the at least one isocyanate component, and wherein the at least one secondary plant compound is partially or completely present in the form of wood particles. When producing inventive PU foams, the starting materials are mixed, wherein linking of the individual components is achieved by the reaction of an isocyanate group (—N═C═O) of a molecule with a hydroxyl group (—OH) of another molecule forming a urethane group (—NH—CO—O—). By admixing the at least one secondary plant compound to the reaction, the secondary plant compound can covalently bond to PU foam, in particular at the isocyanate component. It has been shown that the inventive method allows the production of an environmentally friendly PU foam with modified properties, and that products of use produced therefrom with modified properties are ecologically safe.

Another aspect of the present invention relates to PU foam obtainable by the inventive method.

Another aspect of the present invention relates to the use of a PU foam for producing filters, upholstery goods, mattresses, cushions, sanitary products, cleaning sponges, and/or insulation layers, preferably in textiles, sound insulations and thermal insulations.

### DESCRIPTION OF THE EMBODIMENTS

In the present invention, the terms “PU foam,” “PUR foam,” and “polyurethane foam” relate in particular to a product obtainable by reacting polyisocyanates and polyols or compounds with isocyanate-reactive groups and optionally a propellant. Preferred PU foams are soft PU foams, hard PU foams, and PU integral foams. Especially preferred herein are common soft PU foams based on ether or ester polyols, highly elastic polyurethane cold foams, viscoelastic PU foams, PU hypersoft foams, semi-hard PU foams, and hard PU foams, as well as PU foams with properties between these classifications.

The term “secondary plant compound” with regard to the present invention refers to substances that are neither produced in energy metabolism nor in building (anabolic) or degrading (catabolic) metabolism. They are produced in certain cell types of plants and are different from primary plant materials in that they are not directly vital for the plant. Bio-synthetic pathways leading to the production of secondary plant compounds are summarized under the term of secondary metabolism. Secondary plant compounds are, in contrast to the products of the primary metabolism of the plants, specific chemical metabolic products. These metabolic products are usually limited to a certain type of plant or group and are derived from the primary metabolism. Due to their chemical structure and functional properties, secondary plant compounds are divided into different groups, such as polyphenols, carotenoids, phytoestrogens, glucosinolates, sulfides, terpenes, terpenoids, saponins, protease inhibitors, phytosterols, and lectins. Secondary plant compounds such as isoprenoids, resins, and terpenes are, for example, also present in wood and particles thereof.

The at least one secondary plant compound is, preferably covalently, bonded to PU foam. This means that the at least one secondary plant compound is, preferably covalently, bonded to the isocyanates during the production of the PU foam, preferably by a reaction of polyols with isocyanates. This means that the secondary plant compound, which may to some extent, i.e., partially, or completely consist of wood particles, is thus integrated into the PU foam. This is particularly advantageous because it leads to a distribution of the at least one secondary plant compound within the PU foam. The inventive PU foam therefore comprises the at least one secondary plant compound in its interior structure as well as on the surface. Abrasion, cutting and similar measures on the PU foam do therefore not cause the PU foam to lose its advantageous properties based on the at least one secondary plant compound because the secondary plant compounds are repeatedly “exposed” at the PU foam. “Covalently bonded” as used herein means that at least 5 wt. %, preferably at least 10 wt. %, more preferably at least 20 wt. %, more preferably at least 40 wt. %, more preferably at least 50 wt. %, more preferably at least 60 wt. %, more preferably at least 80 wt. %, of the secondary plant compounds present in the inventive PU foam or of the secondary plant compounds used or added during production of the inventive PU foam are actually covalently bonded in the PU foam. The proportion of covalently bonded secondary plant compounds can be determined by methods known to the skilled person. Based on the method described in DIN 53770, an aqueous extract, which is for example carried out at a pH value of 5.5, can be produced, the secondary plant compounds contained therein can be quantified and compared to the originally used amount of secondary plant compounds.

The inventive PU foam comprises at least one, preferably covalently, bonded secondary plant compound. According to the invention, the at least one secondary plant compound can partially or completely be present in the form of wood particles. “Completely” means that all secondary plant compounds in the inventive PU foam (i.e., 100% of the secondary plant compounds) are present in the form of wood particles. “Partially” means that at least 1 wt. %, preferably at least 5 wt. %, more preferably at least 10 wt. %, more preferably at least 20 wt. %, more preferably at least 30 wt. %, more preferably at least 40 wt. %, more preferably at least 50 wt. %, more preferably at least 60 wt. %, more preferably at least 70 wt. %, more preferably at least 80 wt. %, more preferably at least 90 wt. %, of the secondary plant compounds are comprised in the PU foam in the form of wood particles.

It has been shown that the effect of the at least one secondary plant compounds in the PU foam is particularly pronounced at a certain amount. According to a preferred embodiment of the present invention, the PU foam thus comprises 0.1 to 10 wt. %, preferably 0.2 to 5 wt. %, particularly preferred 0.3 to 3 wt. %, of the at least one secondary plant compound. “Wt. %” as used herein refers to the entire formulation of the PU foam.

In order to provide the inventive PU foam with, for example, antistatic, abrasion-resistant, absorbent, odor-neutralizing, insecticidal, acaricidal, preferably antimicrobial properties or a combination thereof, the at least one secondary plant compound is preferably a terpenoid or a polyphenol.

Terpenes are compounds whose basic structure is based on isoprene units (C5 units). Terpenoids are also based on isoprene units, which are characterized by additional functional groups, while terpenes comprise only hydrocarbons. Terpenoids comprise, among others, alcohol, ether, aldehyde, ketone, carboxylic acid, ester, as well as glycoside groups. Polyphenols are chemical compounds from the phenol group of substances or the group of hydroxy aromatics. Polyphenols are usually found in the edge layers of fruits, vegetables, and grain. Polyphenols have several aromatic rings in their chemical structure and can comprise color pigments, flavorants and tannins and usually protect plants against predators or can attract insects for pollination by their color. In some plants, polyphenols also serve as a protection for the photosynthetic apparatus due to their antioxidant effect and the fact that they filter energy-rich UV-B irradiation.

When classifying terpenoids, usually a distinction is made between acyclic, mono-, bi-, tri-, tetra-, penta-, and polycyclic terpene structures, i.e., molecules without, with one, two, three, four, five or several rings. Depending on the size of the molecule, terpenoids serve as fragrances (e.g., as pheromones or repellents), adhesives, as well as protection against viral, bacterial and fungal diseases. Terpenoids also make up a large proportion of the known essential oils. Essential oils are widely used for repelling insects. A large number of terpenoids also shows antimicrobial activity. Terpenoids are active against bacteria, fungi, viruses, and protozoa.

Cyclic terpenoids, preferably bicyclic terpenoids, are often used as solvents in surface treatment agents, in household products (e.g. shoe polishes, floor cleaning products), as fragrance additives in cosmetics, and are a natural component of plant food (e.g., in oranges, lemons, carrots).

According to the invention, terpenoids, preferably cyclic terpenoids, can be covalently bonded in PU foam to modify the properties of the PU foam. It is thereby possible to “integrate” properties of terpenoids into the PU foam. PU foam modified in this manner thus has properties that are also shown by the terpenoids used.

According to a preferred embodiment of the present invention, the terpenoid is a monocyclic or polycyclic terpenoid, preferably a bicyclic, tricyclic, tetracyclic or pentacyclic terpenoid. According to another preferred embodiment of the present invention, the terpenoid is a monoterpenoid selected from the group consisting of pyrethrin, thymol, cineol, thujanol, perillic acid, linalool, myrcenol, citral, citronellal, geranic acid, junionone, chrysanthemol, menthol, terpineol, verbenol, carveol, piperitone, and camphor, preferably pyrethrin, thymol, cineol, thujanol, and/or perillic acid.

Monoterpenoids consist of two isoprene units, i.e., a basic structure with 10 C atoms. Monoterpenoids are mainly used as fragrances in the industry. By covalently bonding monoterpenoids to the PU foam, for example, a foam serving for avoiding unpleasant odors of textile products, upholsteries, etc. can be provided.

According to another preferred embodiment of the present invention, the terpenoid is a sesquiterpenoid selected from the group consisting of farnesin, bisabolol, armillarin, merulidial, hirsutum acid, nerolidol, zingiberene, germacrane, periplanone, elemol, guaiane, and cedran, preferably farnesin, bisabolol, armillarin, merulidial, and/or hirsutum acid.

Sesquiterpenoids comprise three isoprene units, i.e., a basic structure with 15 C atoms. Sesquiterpenoids are mainly used as fragrances and aromas.

According to another preferred embodiment of the present invention, the terpenoid is a diterpenoid selected from the group consisting of agelasine, larixol, dehydroabietinol, abietic acid, bolegrevilol, aframodial, phytol, retinol, primaran, nimbiol, forskolin, labdanolic acid, cassainic acid, gibberelan, isopimaric acid, dehydroabietinol, and abietic acid, preferably agelasine, larixol, dehydroabietinol, abietic acid, bolegrevilol, and/or aframodial.

Diterpenoids are composed of four isoprene units (2-methylbutadiene) and can be subdivided into open-chain and cyclic compounds. Diterpenoids are, e.g., present in many resins and often have anti-inflammatory properties.

According to another preferred embodiment of the present invention, the terpenoid is a sesterpenoid selected from the group consisting of ircinin, neomanoalide, cericerane, and dehydroircinin.

Sesterterpenoids consist of five isoprene units and are mainly found in lower plants, fungi, or in potato leaves. Sesterpenoids are, among other things, known for their antibacterial effect (e.g., ircinin). Preferably, by covalently bonding sesterpenoids to PU foam, a material with antimicrobial properties can be provided.

According to another preferred embodiment of the present invention, the terpenoid is a triterpenoid selected from the group consisting of limonoids, lanosterol, fusidane, fusidic acid, euphane, dammarane, cucurbitane, cucurbitacin, betulin, and betulinic acid.

Triterpenoids comprise six isoprene units, i.e., a basic structure with 30 C atoms. Tetracyclic triterpenoids (lanosterane type, for example) include the important groups of steroids and the cucurbitacins. Depending on the basic structure, pentacyclic compounds are subdivided into triterpenoids of the oleanane, ursane, and lupine type. These are present, e.g., as triterpenoid alcohols and triterpenoidacids in resins (resino acids and resinols) or as triterpenoid sapogenins (saponins). Many triterpenoids have important biological functions, e.g., as hormones.

According to another preferred embodiment of the present invention, the terpenoid is a tetraterpenoid selected from the group consisting of carotene, crocetin, and lycopene.

Tetraterpenoids comprise eight isoprene units, i.e., the basic structure comprises 40 C atoms. Tetraterpenoids include liposoluble pigments (lipochromes) in archaea, bacteria, plants, and animals. They include carotenes, pure hydrocarbons such as lycopene, and also their oxygen-containing derivatives, the xanthophylls. Bonding a tetraterpenoid to PU foam can, for example, result in coloring/discoloring of the foam.

According to another preferred embodiment of the present invention, the terpenoid is a polyterpenoid selected from the group consisting of betulaprenol, oleanolic acid, ubiquinone, dolochol, and betulaprenol, preferably betulaprenol, oleanolic acid, ubiquinone, and/or dolochol.

According to another preferred embodiment of the present invention, the polyphenol is a polyhydroxyphenol, preferably a tannin, a suberin, or a lignin.

Tannins comprise polyhydroxyphenols with ortho-positioned hydroxy groups, in particular derivatives (ester) of gallic acid (3,4,5-trihydroxybenzoic acid) with glucose and related sugars. Depending on their degree of condensation, tannins can be subdivided into gallotannins (e.g., glucogallin) and ellagitannins (e.g., pendunculagin). The free hydroxy groups allow crosslinking with polymers as well as proteins. Thus, amino acids or proteins present on the surface of cells and viruses can be absorbed by the inventive PU foam. Gases such as oxygen, H2S and ammonia can also be absorbed by the reactive groups of the bonded polyphenols.

Suberin is a hydrophobic biopolymer deposited in the cell walls of plants. As a hydrophobic material, suberin has the natural function of sealing roots and preventing water penetration.

Lignin comprises a group of macromolecules with different monomer building blocks (coumaryl, coniferyl, sinapyl alcohols, etc.). Characteristics of lignin are structures based on phenol complexes (phenylpropanoids) with hydroxy, methoxy, and aryloxy substituents.

Lignin is hydrophobic and has special absorption capacities in the binding area of multivalent metal ions (Fe, Mn, Cr, etc.) as well as parts of UV light with wavelengths in the range of 100 to 300 nm.

By covalently bonding suberin and/or lignin in the PU foam, the material can, for example, obtain hydrophobic, absorptive and/or UV-resistant properties or these properties can be improved.

According to another preferred embodiment of the present invention, the tannin is a gallotannin or an ellagitannin.

According to another preferred embodiment of the present invention, the polyphenol is selected from the group consisting of phytoalexins, preferably resveratrol, flavonolols, preferably taxifolen, catechins, flavonoids, anthocyans, proanthocyanidines, procyanidines, phlobaphenes, and isoflavones.

Phytoalexins are, for example low-molecular compounds with antimicrobial and antioxidant effects, which can be produced by a plant directly after an infection with microorganisms (such as bacteria or fungi) to inhibit spreading, growth, or propagation thereof in the plant. By bonding phytoalexins to PU foam, the material can thus be provided with antimicrobial properties.

According to another preferred embodiment of the present invention, the at least one secondary plant compound is a tree resin, preferably colophonium, mastic, or balsam.

Surprisingly, it has been shown that an essential part of the antibiotic, in particular the antimicrobial, effect of compounds is not only based on the different metabolic effects in microorganisms, but also on the adhesive properties of solid resins (e.g. colophonium). Physical spreading of microbes can be impeded or prevented by covalently bonding a tree resin to PU foam because the microbes stick to the resin due to adhesive forces.

PU foams can, for example, be subdivided into closed-cell or partially closed-cell hard PU foams and open-cell or partially open-cell soft PU foams. Hard PU foams are mainly used as insulating materials or for thermal insulation of buildings. Soft PU foams are used in numerous technical applications in the industry and in the private sector, e.g., for sound insulation, for producing mattresses, or for upholstering furniture. A particularly important market for different types of PU foams, such as conventional soft foams based on ether or ester polyol, hard foams, as well as foams with properties that lie between these classifications, is for example the automobile industry. Here, hard foams can, for example, be used as roof lining, ester foams for the interior lining of doors as well as for die-cut sun visors, cold and soft foams for seat systems. Another particularly important market relates to mattresses and sitting systems for, e.g., living areas, offices, and the like. With regard to soft foams, it can also be distinguished between cold soft foams and hot soft foams.

According to another preferred embodiment of the present invention, the PU foam can thus be a hard PU foam, a soft PU foam, or a viscoelastic PU foam.

PU foam can be produced in different ways. In principle, polyurethane is created by a polyaddition reaction of isocyanate components with polyol components as described above. To foam the polyurethane created during the reaction, propellants (e.g., water) can be added to the mixture of isocyanate components and polyol components.

The isocyanate components of the present invention used are preferably one or more organic polyisocanates with two or more isocyanate functions. In general, any known aliphatic, cycloaliphatic, arylaliphatic, and preferably aromatic multifunctional isocyanate can be used. Examples that can be mentioned here are alkylene diisocyanates with 4 to 12 carbon atoms in the alkylene residue, such as 1,12-dodecane diisocyanate, 2-ethyltetramethylene diisocyanate-1,4, 2-methylpentamethylene diisocyanate-1,5, tetramethylene diisocyanat-1,4, and preferably hexamethylene diisocyanate-1,6 (HMDI), cycloaliphate diisocyanates, such as cyclohexane-1,3- and 1-4-diisocyanate as well as any mixture of these isomers, 1-isocyanato-3,35-trimethyl-5-isocyanatomethylcyclohexane (isophorondiisocyanate or IPDI in short), 2,4- and 2,6-hexahydrotoluylene diisocyanate as well as the corresponding mixtures of isomers, and preferably aromatic di- and polyisocyanates, e.g., 2,4- and 2,6-toluene diisocyanate (TDI) and the corresponding mixture of isomers, methylenedi(phenylisocyanate) (MDI), mixtures of 2,4′- and 2,2′-methylenedi(phenylisocyanate), and polyphenyl polymethylene polyisocyanate (raw MDI), and mixtures of raw MDI and toluene diisocyanates (TDI). The organic di- and polyisocyanates can be used alone or in the form of mixtures. It is also possible to use isocyanates that have been modified by the incorporation of urethane, uretdione, isocyanurate, allophanate and other groups, so-called modified isocyanates. Particularly well suited organic polyisocyanate that are therefore particularly preferably used are various isomers of toluene diisocyanate (2,4- and 2,6-toluene diisocyanate (TDI), in their pure form or as mixtures of isomers of different compositions), 4,4′-methylenedi(phenylisocyanate), so-called “crude MDI” or “polymeric MDI” (contains, in addition to the 4,4′-, also the 2,4′- and 2,2′-isomers of MDI and higher nuclear products), as well as the binuclear product referred to as “pure MDI” consisting mainly of 2,4′- and mixtures of 4,4′-isomers or prepolymers thereof.

Polyols suitable as polyol component in the sense of the present invention is any organic substance with groups reactive with isocyanates, preferably OH groups. Preferred polyols is any polyether polyol and/or polyester polyol and/or hydroxyl groups containing aliphatic polycarbonates, in particular polyether polycarbonate polyols and/or polyols of natural origin, so-called “natural oil based polyols” (NOPs) commonly used for producing polyurethane systems, in particular PU foams. Preferred usable polyether polyols can be produced by known methods, e.g., by anionic polymerization of alkylene oxides in the presence of alkali hydroxides, alkyl alcoholates, or amines as catalysts, and with the addition of at least one starter molecule preferably containing 2 or 3 bound reactive hydrogen atoms, or by cationic polymerization of alkylene oxides in the presence of Lewis acids, e.g., antimony pentachloride or boron trifluoride etherate, or by double metal cyanide catalysis. Suitable alkylene oxides contain 2 to 4 carbon atoms in the alkylene residue. Examples are tetrahydrofuran, 1,3-propylene oxide, 1,2- or 2,3-butylene oxide; preferably ethylene oxide and 1,2-propylene oxide are used. The alkylene oxides can be used alone, cumulatively, blockwise, in alternating sequence, or as mixtures. Starter molecules may in particular be compounds with at least 2, preferably 2 to 8, hydroxy groups or with at least two primary amino groups in the molecule. Starter molecules that can be used are, e.g., water, 2-, 3- or 4-valent alcohols such as ethylene glycol, propanediol-1,2 and -1,3, diethylene glycol, dipropylene glycol, glycerol, trimethylol propane, pentaerythrit, castor oil, etc., higher polyfunctional polyols, in particular sugar compounds, e.g. glucose, sorbitol, mannitol, and sucrose, polyvalent phenols, resoles, e.g., oligomeric condensation products of phenol and formaldehyde, and Mannich condensates of phenols, formaldehyde, and dialkanolamines, as well as melamine, or amines such as aniline, EDA, TDA, MDA, and PMDA, particularly preferred TDA and PMDA. The choice of the suitable starter molecule depends on the respective field of application of the resulting polyether polyol during the polyurethane production (e.g., for producing soft PU foams, higher molecular triols are used than for producing hard PU foams).

Preferred usable polyester polyols are based on esters of multivalent aliphatic or aromatic carboxylic acids, preferably with 2 to 12 carbon atoms. Examples of aliphatic carboxylic acids are succinic acid, glutaric acid, adipic acid, suberic acid, azelaic acid, sebacic acid, decanedicarboxylic acid, maleic acid, and fumaric acid. Examples of aromatic carboxylic acids are phthalic acid, isophthalic acid, terephthalic acid, and the isomeric naphthalene dicarboxylic acids. The polyester polyols are obtained by condensation of these multivalent carboxylic acids with multivalent alcohols, preferably diols or triols with 2 to 12, particularly preferred 2 to 6, carbon atoms, preferably trimethylol propane and glycerol.

Preferred usable polyether polycarbonate polyols are polyols containing carbon dioxide bonded as a carbonate. Since carbon dioxide is a by-product of many processes in the chemical industry, the use of carbon dioxide as co-monomer in alklyene oxide polymerizations is particularly interesting from a commercial point of view. Partially replacing alkylene oxides in polyols by carbon dioxide has the potential to strongly decrease the production costs of polyols. In addition, the use of CO₂ as co-monomer is ecologically very beneficial because this reaction represents the transformation of a greenhouse gas into a polymer. The production of polyether polycarbonate polyols by attaching alkylene oxides and carbon dioxide to H-functional starting substances by using catalysts has been known for a long time.

According to another preferred embodiment of the present invention, the PU foam is produced based on polyether and/or polyester polyol and toluene-2,4-diisocyanate and/or methylenedi(phenylisocyanate).

According to another preferred embodiment of the present invention, the PU foam has open or closed cells. With regard to the present invention, “open cells” means that a foam has high air permeability (=porosity). Air permeability of a foam can be determined by means of dynamic pressure measurement on the foam. This dynamic pressure measurement can be conducted according to EN 29053. If the measured dynamic pressure is provided in mm water column, open-cell PU foams, in particular soft PU foams, have a dynamic pressure of preferably less than 100 mm, preferably ≤50 mm water column, determined according to the described measuring method. In the present invention, “closed cells” refers to a foam having nearly closed cells within the foam material, i.e., cells with only a very small opening. Due to the small size of the openings, the air re-enters slowly after compression, which results in slower reshaping. Closed-cell PU foam preferably has a dynamic pressure of at least 300 mm water column.

The at least one secondary plant compound is bonded to or “integrated” into the PU foam by covalent bonding between the reactive groups of the isocyanate component and the at least one secondary plant compound. In other words, this means that there is not only an adhesive connection or a physical connection between the at least one secondary plant compound and the PU foam or its isocyanate component, but mainly a chemical, covalent bond. In addition to secondary plant compounds, the PU foam may comprise further substances that change the properties of the material. These substances can enhance or expand the properties of the PU foam obtained by the secondary plant compounds. According to another preferred embodiment of the present invention, the PU foam thus comprises light stabilizers, pigments, wood particles, biocidal, acaricidal and/or fungicidal agents.

In another preferred embodiment of the present invention, the secondary plant compounds are partially or completely introduced in the form of finely divided plant parts, preferably finely divided wood parts or wood particles, or seeds. The finely divided plant parts can enhance or expand the properties of secondary plant compounds that have not been introduced by the finely divided plant parts. The finely divide plant parts can, depending on their origin, contain a specific high proportion of secondary plant compounds. Therefore, the finely divided plant parts can be introduced into PU foam based on their natural composition of secondary plant compounds for different applications. Preferably, the secondary plant compounds can be introduced in the form of wood particles together with other secondary plant compounds. In this manner, for example, larch wood with a high content of diterpenoid can be advantageously combined with an addition of isolated (e.g., extracted) oak tannin. The finely divided plant parts that are introduced have the same origin, or mixtures of finely divided plant parts can have different origins. Preferably, the secondary plant compounds can be introduced partially or completely in the form of finely divided plant parts, preferably wood particles, of different origins. Thus, the different natural properties of the secondary plant compounds that are introduced can be combined and utilized. For example, pine wood particles and stone pine particles can be introduced in order to combine the naturally contained secondary plant compounds of the woods. Preferably, the secondary plant compounds are introduced partially or completely in the form of finely divided wood parts or wood particles. The finely divided wood parts or wood particles that are introduced are preferably native finely divided wood parts or wood particles. The term “native finely divided wood parts or wood particles” refers to finely divided wood parts or wood particles that have not been processed by carbonization, charring, or burning thereof.

According to a preferred embodiment of the present invention, the wood particles have a particle size of less than 50 μm, preferably of less than 40 μm, more preferably of less than 30 μm, more preferably of less than 20 μm, more preferably of 0.1 μm to 20 μm, more preferably of 0.5 to 10 μm, more preferably of 1 μm to 5 μm. Such finely divided wood particles can, for example, be produced by cryogenic grinding, preferably by means of impact mills or colloid mills.

The size of the wood particles can preferably be determined by means of a sieve analysis according to DIN 66165-1-2016-08 or DIN 66165-2. At least 70%, preferably at least 80%, more preferably at least 90%, more preferably at least 95%, more preferably at least 99%, in particular 100%, of the inventively used wood particles have the particle size mentioned above. The wood particles can have any shape.

Surprisingly, it has been shown that the introduction of wood particles having a particle size of less than 50 μm leads to some advantages. Wood is, according to its biological structure, structured in fibrils and thus shows a defined longitudinal orientation. This structure mainly serves for maintaining the mechanical strength of trees and bushes. Fibrils are almost exclusively composed of cellulose strands that are embedded in a mixture of (non-oriented) substances between cells (e.g. hemicellulose, lignin). According to the present invention, this specific structure is maintained during the production of wood particles as mentioned above because the wood is preferably split in the longitudinal direction, which leads to an undesired, fiber-like longitudinal orientation of the ground material. By means of microscopic examinations it has been shown that the longitudinal structure of the fibrils is broken only when grinding below the fibril diameter (of approx. 0.5 mm to 0.1 mm, depending on the wood type) is conducted. This is important because introduced wood particles with a particle size of more than 50 μm have corresponding fibril diameters and are thus prone to accumulation/entanglement. This effect is particularly important when wood particles are admixed to a high-viscous polyol component. Homogenization is therefore only possible with great effort and is, due to the “batch requirement” incompatible with continuous foaming. Such agglomerates can lead to blockings in high-pressure mixing chambers and their inlets and disproportionately hinder the use. It has therefor surprisingly been shown that agglomeration/entanglement of the introduced wood particles can be prevented with a particle size of less than 50 μm, preferably of less than 30 μm. Further, it has been found that the desired release of the secondary plant compounds into the polyol matrix takes place within an acceptable period of time only below a particle size of 50 μm so that the time that is necessary for mixing with isocyanate is sufficient to guarantee the desired, inventive, covalent bonding of the secondary plant compounds to the PU foam. It has also been shown that such fine milling leads to problems, in particular with elastic coniferous woods (softwood), while cryogenic milling with the use of liquid nitrogen or dry ice can lead to satisfactory results. In addition, this milling variation has the advantage that reactive secondary plant compounds are protected against premature degradation, such as oxidation. Preferably, further additives, such as colorants, light protectants, UV stabilizers, but also eluates of secondary plant compound from foreign origin can be added during the milling procedure and homogenized optimally. Any solvent (but also water from wood absorption) can evaporate during this process step and does therefore not hinder subsequent PU foaming.

According to another preferred embodiment of the present invention, the wood particles are selected from softwood particles, preferably spruce wood particles, fir wood particles, pine wood particles, stone pine wood particles, cedar wood particles, thuja wood particles, yew wood particles, or larch wood particles, hardwood particles, preferably beech wood particles, poplar wood particles, birch wood particles, oak wood particles, or eucalyptus wood particles, or mixtures thereof.

It has been shown that it is advantageous to adjust the proportion of the secondary plant compound and the wood particles in order to accentuate the desired effects even more.

A further aspect of the present invention relates to a method for producing the inventive PU foam.

In the inventive production of the inventive PU foam, preferably at least one polyol component and at least one isocyanate component are reacted with each other, optionally in the presence of propellants, catalysts, with the admixture of the at least one secondary plant compound. Usable polyol components and isocyanate components according to the present invention have already been described above. Depending on the chain length and the number of branchings of the polyol component, mechanical properties of the PU foam may be affected. Of course, a skilled person will choose the respective amounts of the components required for producing the different PU foam types, e.g., hot, cold, ester soft PU foams, or hard PU foams in order to obtain the respectively desired polyurethane type, in particular PU foam type. The inventive production of PU foams can be conducted according to any common method known to the skilled person. The inventive method can be conducted continuously or discontinuously.

Catalysts that can be used according to the present invention can be any catalysts for isocyanate-polyol (urethane formation) and/or isocyanate-water (amines and carbon dioxide formation) and/or isocyanate dimerization (uretdione formation), isocyanate trimerization (isocyanurate formation), isocyanate-isocyanate with cleaving of CO₂ (carbodiimide formation) and/or isocyanate-amine (urea formation) and/or “secondary” cross-linking reactions, such as isocyanate-urethane (allophanate formation) and/or isocyanate-urea(biuret formation) and/or isocyanate-carbodiimide (uretonimine formation) reactions. Suitable amounts of catalysts to be used depend on the type of the catalyst.

Suitable catalysts in the sense of the present invention are, for example, substances that catalyze one of the previously mentioned transformations, in particular the gel reaction (isocyanate-polyol), the propelling reaction (isocyanate-water) and/or the di- or trimerization of the isocyanate. Such catalysts are preferably nitrogen-containing compounds, in particular amines or ammonium salts, and/or metal-containing compounds. Suitable nitrogen-containing compounds as catalysts, in the following also referred to as nitrogen-containing catalysts, within the meaning of the present invention are any nitrogen-containing compounds according to the state of the art that catalyze one of the isocyanate reactions mentioned above and/or or can be used for producing polyurethanes, in particular polyurethane foams. Suitable metal-containing compounds as catalysts, in the following also referred to as metal-containing catalysts, within the meaning of the present invention are all metal-containing compounds according to the state of the art that catalyze any of the isocyanate reactions mentioned above and/or can be used for producing polyurethanes, in particular polyurethane foams. For example, they can be selected from the group of metalloorganic or organometallic compounds, metalloorganic or organometallic salts, organic metal salts, inorganic metal salts, as well as from the group of charged or uncharged metal-containing coordination compounds, in particular metal chelate complexes.

Suitable propellants usable in the sense of this invention are gases, e.g., liquefied CO₂, and highly volatile liquids, e.g. hydrocarbons with 4 or 5 carbon atoms, preferably cyclo-, iso- and n-pentane,—as long as not ozone-depleting-hydrofluorocarbons, preferably HFC 245fa, HFC 134a, and HFC 365mfc, but also olefinic hydrofluorocarbons such as HFO 1233zd or HFO1336mzzZ, hydrochlorofluorocarbons, preferably HCFC 141b, oxygen-containing compounds such as methyl formate and dimethoxymethane. In addition to physical propellants, other chemical propellants that react with isocyanates by producing gases, e.g. formic acid, carbamates, or carbonates, may also be used. In the case of open-cell soft PU foams, water is preferably used as propellant.

According to another preferred embodiment of the present invention, the at least one secondary plant compound is admixed in the form of an extract or eluate.

Secondary plant compounds can be obtained by methods like water steam distillation, extraction, or chromatography. For example, young plants usually provide terpenoid hydrocarbons, and older plants increasingly provide oxygen-containing derivatives such as alcohols, aldehydes, and ketones. Methods for obtaining secondary plant compounds are known from the state of the art. The term “extract” as used in the present invention comprises extracts with a solid, liquid and/or oily consistency from plants, in particular fruits, roots, rhizomes, stems, shoots, leaves, pits, or seeds thereof, which were obtained by extraction. An “eluate” as used in the present invention refers to a solid, liquid and/or oily substance separated or extracted from plants, in particular fruits, roots, rhizomes, stems, shoots, leaves, pits, or seeds thereof.

One advantage of usable extracts and eluates is the natural composition of the components of the secondary plant compounds contained. A particular advantage is that the bioavailability of the secondary plant compounds contained in extracts may be higher than when synthetic compositions are used.

Another advantage of the use of eluates is their better distributability in the polyol component because, for example, terpenoids are highly soluble in the polyol component at the preferably used amounts. In the course of polyaddition with isocyanate, there is a particularly pronounced, homogeneous distribution in the foam and thus also on the accessible cell surfaces.

According to a particularly preferred embodiment of the present invention, the at least one secondary plant compound is admixed to the at least one polyol component.

The at least one secondary plant compound is able to form covalent bonds with the reactive groups of the isocyanate component. It is therefore advantageous that the at least one secondary plant compound is admixed to the at least one polyol component to prevent a premature reaction between the isocyanate component and the at least one secondary plant compound.

According to another preferred embodiment of the present invention, the PU foam is used for producing filters, upholstery goods, mattresses, cushions, sanitary products, cleaning sponges, and/or insulation layers, preferably in textiles, sound insulations and thermal insulations.

For example, the absorption properties of foams play an important role in a number of applications. Here, it is important that the foam shows a high absorption capacity with a subsequent rapid release rate of the absorbed moisture stored therein. The present invention allows the use of a modified PU foam with increased absorption properties for absorbing, for example, body fluids like sweat, blood, or urine. Due to these properties, such PU foams are suitable for use in wound dressing materials.

Another application comprises protection against microbes through the absorption and/or elimination of germs on filter materials, upholstery goods, mattresses, cushions, sanitary products, medical products, cleaning products, or insulation layers. Antimicrobial substances are widely used in daily life to prevent the spreading of microbes and microbial infections, e.g., in the healthcare sector, in the food industry, in agriculture, or in common household products. A major problem resulting from the extensive use of such substances is, however, that the environment is constantly contaminated by fungicidal and/or bactericidal substances. Such contamination may ultimately lead to the development of antibiotic-resistant microbial strains. When using the present invention, physical absorption of bacteria, viruses, molds, and/or their spores on PU foam is a big advantage because it allows the prevention of the use of physiologically and ecologically questionable fungicides and antibiotics.

### EXAMPLES

In Examples 1 to 4, an open-cell soft foam according to the state of the art was produced, wherein a propylene oxide-polyether-polyol (functionality of 3, MW 3500, OH number 50), isocyanate (toluene-2,4-diisocyanate (TDI) 80/20, NCO index 105) and a propellant (water/TDI) were used. The density of the PU foam produced was 45-50 kg/m³.

### Example 1

Before foaming (mixing with isocyanate), the polyol batch was homogeneously added 6 wt. % of micronized pine wood (fineness D50=15 μm), 0.7 wt. % of ellagitannin from the French Limousin oak (Quercus robur), and 0.1 wt. % perillic acid (wt. % refers to the entire formulation of the foam).

The yellow/orange soft PU foam obtained showed:
a) fungicidal properties (tested according to DIN EN 14119)
b) an inhibition of the fertility of eggs of the house dust mite by more than 95%
c) an antiviral effect in an in vitro test according to ISO 18184.

Due to the properties found, this soft PU foam is suitable for use as a filter, in mouth-nose masks, or as upholstery material (bedroom and/or living room).

### Example 2

In analogy with Example 1, in this example a polyol batch was added 3 wt. % of micronized larch wood (D50=5 to 10 μm), 1.5 wt. % of mastic, 0.5 wt. % of thyme oil as eluate from Thymus vulgaris (contained agents are, among others, carvacrol, thymol, cymene, geraniol as well as flavones and tannins as polyphenols), and 0.3 wt. % of HALS 1 UV stabilizer (Lowilite 77) for avoiding discolorations.

The soft PU foam obtained showed:
a) bactericidal properties (DIN EN ISO 20743)
b) anti-inflammatory properties.

Due to the properties found, this soft PU foam is suitable for use as wound pads, in dressing material, and in mattresses.

### Example 3

In analogy with Example 1, in this example a polyol batch was added 2.5 wt. % of lignin, 0.5 wt. % of tannin (ellagitannin from oak), 1.5 wt. % of an eluate from stone pine wood and eucalyptus in a ratio of 1:1, and 0.2 wt. % of perillic acid.

The soft PU foam obtained showed:
a) bactericidal properties (DIN EN ISO 20743)
b) fungicidal properties (tested according to DIN EN 14119).

Due to the properties found, this soft PU foam is suitable for use as a filter, in masks, wound dressings, and in mattresses.

### Example 4

In analogy with Example 1, in this example a polyol batch was added 2 wt. % of colophonium from Nordic pines, 0.5 wt. % of an eluate from salvia, rosemary and ivy in a ratio of 2:1:1 (also contained oleanolic acid), 0.3 wt. % of cineol from eucalyptus oil, and 0.3 wt. % of HALS 1 UV stabilizer (Lowlite 77) for avoiding discolorations.

The soft PU foam obtained showed:
a) bactericidal properties (DIN EN ISO 20743)
b) fungicidal properties (tested according to DIN EN 14119)
c) acaricidal properties, in particular by physical adhesion effects on mites and eggs thereof.

Due to the properties found, this soft PU foam is suitable for use in mattresses and furniture upholstery, filters, in particular fine particle filters for vacuum cleaners, and general sanitary uses.

### Example 5

In this example, a closed-cell hard foam according to the state of the art was produced. It was produced with propylene oxide-polyether-polyol (functionality of 6, MW 450, OH number 50), isocyanate (methylenedi(phenylisocyanate) (MDI) 29% NCO, NCO index 110), and a propellant (cyclopentane). The PU foam had a density of 35-40 kg/m³.

The polyol was, before foaming (mixing with isocyanate), added 4 wt. % of lignin, 2 wt. % of tannin (ellagitannin from oak), 0.2 wt. % of perillic acid, and 0.3 wt. % of HALS 1 UV stabilizer(Lowilite 77).

Due to the addition of lignin, which served as pore nucleating agent, the hard PU foam obtained had particularly fine pores. The foam showed excellent resistance against mold infestation (Aspergillus niger), so that this foam is particularly well suited for the use as insulation material in residential buildings.

### Example 6

### Eluation Test

In an eluation test with distilled water (pH 7), the foams of Examples 1 to 5 showed no washout effects, which indicates the covalent bonding of the additives.

1. A PU foam comprising at least one secondary plant compound bonded thereto, wherein the at least one secondary plant compound is a tannin and partially present in the form of wood particles.

2. The PU foam according to claim 1, wherein the PU foam comprises 0.1 to 10 wt. % of the at least one secondary plant compound.

3. The PU foam according to claim 1, wherein terpenoid or a polyphenol is covalently bonded to the PU foam.

4. The PU foam according to claim 1, wherein the tannin is a gallotannin or an ellagitannin.

5. The PU foam according to claim 1, wherein a tree resin is covalently bonded to the PU foam.

6. The PU foam according to claim 1, wherein the PU foam is a hard PU foam, a soft PU foam, or a viscoelastic PU foam.

7. The PU foam according to claim 1, wherein the PU foam is produced based on polyether and/or polyester polyol and toluene-2,4-diisocyanate and/or methylenedi(phenylisocyanate).

8. The PU foam according to claim 1, wherein the PU foam has open or closed cells.

9. The PU foam according to claim 1, wherein the PU foam comprises light stabilizers, pigments, biocidal, acaricidal and/or fungicidal agents.

10. The PU foam according to claim 1, wherein the wood particles have a particle size of less than 50 μm.

11. The PU foam according to claim 1, wherein the wood particles are selected from softwood particles, hardwood particles, or mixtures thereof.

12. A method for producing the PO foam according to claim 1 comprising the step of reacting at least one polyol component with at least one isocyanate component in the presence of a propellant and at least one catalyst, which catalyzes the reactions of the isocyanate polyol, wherein at least one secondary plant compound is admixed during the reaction of the at least one polyol component with the at least one isocyanate component, and wherein the at least one secondary plant compound is a tannin and partially present in the form of wood particles.

13. The method according to claim 12, wherein the at least one secondary plant compound is admixed in the form of an extract or eluate, when the at least one secondary plant compound is partially present in the form of wood particles.

14. The method according to claim 12, wherein the at least one secondary plant compound is admixed to the at least one polyol component.

15. A PU foam formed by the method according to claim 12.

16. An article of manufacture made from a PU foam according to claim 1, wherein the article of manufacture is selected from the group consisting of filters, upholstery goods, mattresses, cushions, sanitary products, cleaning sponges, and insulation layers, optionally in textiles, sound insulations, or thermal insulations.

17. The PU foam according to claim 1, wherein the PU foam comprises 0.2 to 5 wt. %, or 0.3 to 3 wt. %, of the at least one secondary plant compound.

18. The PU foam according to claim 5, wherein the tree resin comprises colophonium, mastic, or balsam.

19. The PU foam according to claim 10, wherein the wood particles have a particle size of less than 40 μm, or less than 30 μm, or less than 20 μm, or in a range of 0.1 μm to 20 μm.

20. The PU foam according to claim 1, wherein the softwood particles are selected from spruce wood particles, fir wood particles, pine wood particles, stone pine wood particles, cedar wood particles, thuja wood particles, yew wood particles, or larch wood particles, and the hardwood particles are selected from beech wood particles, poplar wood particles, birch wood particles, oak wood particles, or eucalyptus wood particles.
